SEQUENCE LISTING (2 sequences)

SEQ ID NO: 1 - DNA, 52 bp, synthetic construct
  source 1..52: mol_type = other DNA
tcgtcggcagcgtcagatgtgtataagagacaggtgycagcmgccgcggtaa

SEQ ID NO: 2 - DNA, 54 bp, synthetic construct
  source 1..54: mol_type = other DNA
gtctcgtgggctcggagatgtgtataagagacagggactacnvgggtwtctaat

(19) United States
(12) Patent Application Publication
(10) Pub. No.: US 2026/0356772 A1
(43) Pub. Date: Nov. 12, 2026

(54) METHOD FOR PRODUCING PLANT GROWTH PROMOTER, METHOD FOR GROWING PLANTS, AND PLANT GROWTH PROMOTER

(71) Applicant: KABUSHIKI KAISHA TOYOTA CHUO KENKYUSHO, Nagakute-shi, Aichi-ken (JP)

(72) Inventors: Fumihiko HOSHINO, Nagakute-shi (JP); Semon TAKASU, Nagakute-shi (JP); Masami YAMAMOTO, Nagakute-shi (JP); Toshihide OHMORI, Nagakute-shi (JP); Hideto TAKEKAWA, Nagakute-shi (JP); Masayoshi KARASAWA, Nagakute-shi (JP); Keisuke ICHIGE, Nagakute-shi (JP); Hiroki SUGIMOTO, Nagakute-shi (JP); Yoshikazu FURUTA, Nagakute-shi (JP); Hinano MIZUNO, Nagakute-shi (JP)

(73) Assignee: KABUSHIKI KAISHA TOYOTA CHUO KENKYUSHO, Nagakute-shi, Aichi-ken (JP)

(21) Appl. No.: 19/488,171

(22) PCT Filed: May 30, 2024
(86) PCT No.: PCT/JP2024/019953

§ 371 Date: Nov. 26, 2025

(30) Foreign Application Priority Data
Jun. 1, 2023 (JP) 2023-090813

(51) Int. Cl. C05D 9/02

(52) U.S. Cl. CPC C05D 9/02

(57) ABSTRACT

There is provided a method for producing a plant growth promoter, comprising: providing an adsorbent configured to adsorb at least either one of a bacterium and an organic substance; soaking the adsorbent in water for growth that is water where an aquatic organism is grown; and obtaining the adsorbent taken out from the water for growth, as the plant growth promoter.

### CROSS-REFERENCE TO RELATED APPLICATIONS

This is a national phase of PCT/JP2024/019953, filed May 30, 2024, which claims the benefit of JP 2023-090813, filed Jun. 1, 2023. The disclosure of the prior applications is hereby incorporated by reference herein in its entirety.

### REFERENCE TO AN ELECTRONIC SEQUENCE LISTING

The present application contains a Sequence Listing that has been submitted electronically and is hereby incorporated by reference in its entirety. The electronic Sequence Listing is named Sequence_Listing, was created on Oct. 28, 2025, and is 2,761 bytes in size.

### TECHNICAL FIELD

The present disclosure relates to a method for producing a plant growth promoter, a method for growing a plant, and a plant growth promoter.

### BACKGROUND

A variety of techniques have conventionally been known as the technology of promoting the growth of a plant. Compost, chemical fertilizers, biostimulants and the like are generally utilized to promote the growth of a plant. Known techniques, in addition to this general technique, include a technique of causing an inorganic substance containing nitrogen and/or phosphorus to be adsorbed to or carried on a carbide and a technique of utilizing such an inorganic substance adsorbed to or carried on the carbide for the growth of a plant. For example, PTL 1 discloses a configuration that causes a carbide obtained by carbonization of a material plant treated by introduction of calcium to be brought into contact with an acid solution and thereby have the ion adsorptive capacity and uses the carbide having the ion adsorptive capacity for purification of the breeding water or the like in a culture farm. PTL 2 discloses a configuration that causes nitrate nitrogen and nitrite nitrogen to be adsorbed to a carbon material having the ion adsorptive capacity as described above and places the carbon material after the adsorption into the soil to be used as a soil enrichment fertilizer for promoting the growth of a plant. PTL 3 discloses a configuration that mixes an iron phosphate-containing carbide, which is obtained by bringing an iron compound-carried carbide into contact with a phosphate-containing material, with an organic fertilizer source to be treated under an aerobic condition and further adds a base to produce compost serving as a water-soluble phosphorus supply source. PTL 4 discloses a configuration that adds used active carbon that is used for advanced water treatment and that has a certain cation exchange capacity or a certain exchangeable lime content, to an appropriate medium, so as to promote the initial growth of a plant and to grow inoculated useful microorganisms in the soil. PTL 5 and NPTL 1 disclose a rice fertilizer containing a fermentation product of Lemna (duckweed), which is grown with absorption of an abundance of nutritive salts in an eutrophicated water area, as a different fertilizer from the inorganic substance described above.

### CITATION LIST

### Patent Literatures

PTL 1: Japanese Patent 2005-296933A
PTL 2: Japanese Patent 2005-306716A
PTL 3: Japanese Patent 2022-67352A
PTL 4: Japanese Patent 2022-67352A (Japanese Patent No. 5534850)
PTL 5: Japanese Patent 2016-160129A

### Non-Patent Literatures

NPTL 1: The Hokuriku Crop Science Vol. 56, 2021, 56, p 5-10

### SUMMARY

### Technical Problem

The technique of promoting the plant growth by using the carbide with the inorganic substance adsorbed thereto or carried thereon as described in PTL 1 to PLT 3, however, limits the nitrate nitrogen, nitrite nitrogen, phosphorus and the like as the adsorbed or carried useful components, to the generally used chemical fertilizers or to a trace amount of inorganic components included in the compost. The carbide of PTL 4 needs a soaking process for a long time period as long as several years to provide highly purified drinking water and is required to have a certain cation exchange capacity as the indication of fertilizer retainability or to have a lime component serving as the fertilizer. PTL 5 and NPTL 1 utilize a different type of fertilizer from the conventionally known inorganic substances containing nitrogen and/or phosphorus but have a problem of requiring a complicated process, such as a fermentation process and an extraction process, prior to the use. There is accordingly a demand for a technique involved in a plant growth promoter that is more readily usable and that has superior plant growth promoting capacity than ever.

### Solution to Problem

According to one aspect of the present disclosure, there is provided a method for producing a plant growth promoter. This method for producing the plant growth promoter comprises providing an adsorbent configured to adsorb at least one of a bacterium and an organic substance; soaking the adsorbent in water for growth where an aquatic organism is grown; and obtaining the adsorbent taken out from the water for growth, as the plant growth promoter.

The method for producing the plant growth promoter according to this aspect enables a useful element that has not conventionally been used for promoting the growth of a land plant and that includes, for example, a bacterium present in the water for growth as a water sphere and/or an organic substance derived from an aquatic organism, to be obtained for the purpose of promoting the growth of the land plant by an extremely simple operation of soaking the adsorbent in the water for growth where the aquatic organism is grown and subsequently taking out the adsorbent from the water for growth.

### BRIEF DESCRIPTION OF DRAWINGS

FIG. 1 is a flowchart showing a method of promoting the plant growth using a plant growth promoter;

FIG. 2A is an explanatory diagram schematically illustrating a method of producing a plant growth promoter;

FIG. 2B is an explanatory diagram schematically illustrating another method of producing a plant growth promoter;

FIG. 2C is an explanatory diagram schematically illustrating another method of producing a plant growth promoter;

FIG. 3A is an explanatory diagram showing the properties of waters for growth used for production of the plant growth promoters;

FIG. 3B is an explanatory diagram showing the properties of the waters for growth used for production of the plant growth promoters;

FIG. 4 is an explanatory diagram showing the properties of waters for growth at the end of soaking in the processes of producing Hy charcoal and Cw charcoal;

FIG. 5 is an explanatory diagram collectively showing test conditions of respective sample groups in a plant growth test;

FIG. 6 is an explanatory diagram showing plant postures as the results of the plant growth test;

FIG. 7 is an explanatory diagram showing measurement results of raw weights of overground parts as the results of the plant growth test;

FIG. 8 is an explanatory diagram showing measurement results of raw weights of overground parts as the results of the plant growth test;

FIG. 9 is an explanatory diagram showing plant postures as the results of the plant growth test;

FIG. 10 is an explanatory diagram showing measurement results of raw weights of overground parts as the results of the plant growth test;

FIG. 11 is an explanatory diagram showing measurement results of raw weights of overground parts as the results of the plant growth test;

FIG. 12 is an explanatory diagram showing measurement results of raw weights of overground parts as the results of the plant growth test;

FIG. 13 is an explanatory diagram showing measurement results of raw weights of overground parts as the results of the plant growth test;

FIG. 14 is an explanatory diagram showing measurement results of raw weights of overground parts as the results of the plant growth test;

FIG. 15 is an explanatory diagram showing plant postures as the results of the plant growth test;

FIG. 16 is an explanatory diagram showing measurement results of raw weights of overground parts as the results of the plant growth test;

FIG. 17 is an explanatory diagram showing plant postures as the results of the plant growth test;

FIG. 18 is an explanatory diagram showing measurement results of raw weights of overground parts as the results of the plant growth test;

FIG. 19 is an explanatory diagram showing measurement results of raw weights of overground parts as the results of the plant growth test;

FIG. 20 is an explanatory diagram showing primer sequences used for PCR amplification;

FIG. 21 is an explanatory diagram showing information with regard to a bacterial flora distribution obtained by environmental DNA analysis; and

FIG. 22 is an explanatory diagram showing the results of Topic analysis from the information with regard to the bacterial flora distribution.

### DETAILED DESCRIPTION

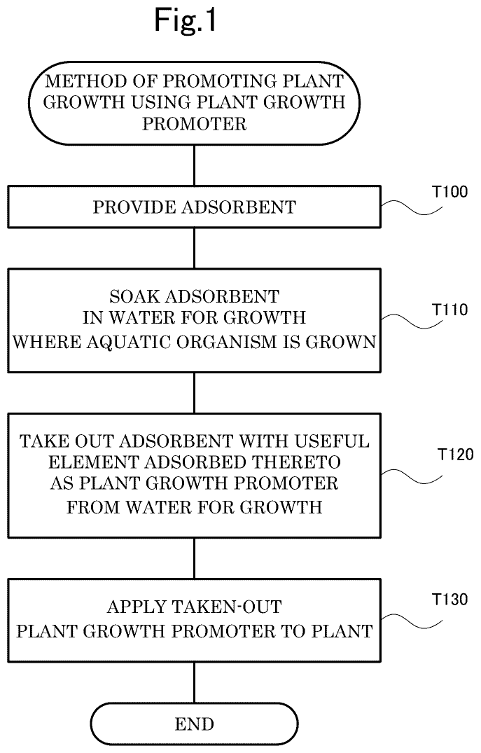

FIG. 1 is a flowchart showing a method of promoting the plant growth using a plant growth promoter according to one embodiment of the present disclosure. In FIG. 1, processes T100 to T120 show a method of producing the plant growth promoter.

The method of producing the plant growth promoter first provides an adsorbent (process T100). The adsorbent provided in the process T100 may be any adsorbent that is capable of adsorbing at least one of a bacterium and an organic substance. The adsorbent may be configured by using a carbon material (carbon-containing material) or a biological organic material. For example, in the case where the plant growth promoter is used by being mixed with the soil as described later, the adsorbent configured by using the carbon material or the biological organic material suppresses the adsorbent retained in the ground from having undesirable effects on the environment and the like. In the case of the adsorbent configured by using the carbon material, the content of carbon in the composition of the adsorbent is preferably, for example, not lower than 30% by mass, is more preferably not lower than 50% by mass, and is furthermore preferably not lower than 70% by mass.

In the case of the adsorbent configured by using the carbon material, a biochar made of a bioresource, such as wood charcoal or bamboo charcoal, may be preferably used for the carbon material. When the plant growth promoter of the embodiment is used to promote the plant growth, for example, in the case where the plant growth promoter is used by being mixed with the soil as described later, the use of the carbon material described above as the adsorbent enables carbon to be retained in the ground. This achieves the carbon negative state. Furthermore, it is preferable that the adsorbent is porous or fibrous. The porous or fibrous adsorbent readily provides a high specific surface area of the adsorbent and thereby enables a useful element, such as a bacterium and/or an organic substance, to be adsorbed at a higher density to the surface of the adsorbent. It is especially preferable that such an adsorbent is made of a hydrophobic porous material.

It is also preferable that the adsorbent of the embodiment does not substantially have the ion exchange capacity or more specifically the anion exchange capacity. The state that the adsorbent “does not substantially have the ion exchange capacity” means that the adsorbent is not subjected to a special treatment for providing the ion exchange capacity or more specifically is not subjected to a treatment for adding an anion to exert the ion exchange capacity. The plant growth promoter of the embodiment is produced by soaking the adsorbent in water for growth where an aquatic organism is grown and causing a useful element, such as a bacterium and/or an organic substance, in the water for growth to be adsorbed to the adsorbent as described later. In the case where nitrate nitrogen and nitrite nitrogen, which are inorganic components as in compost and chemical fertilizers conventionally used for promoting the plant growth, are included in the water for growth and nitrite ion and nitrate ion are present in the water for growth, the adsorbent having the anion exchange capacity adsorbs these anions by ion exchange. This results in interfering with adsorption of useful elements other than the anions, for example, bacteria and organic substances present in the water for growth. The adsorbent of the embodiment, however, does not substantially have the ion exchange capacity. Even in the case where the adsorbent is soaked in the water for growth where nitrite ion and nitrate ion are present, the adsorbent of the embodiment can thus adsorb the useful element, such as the bacterium and/or the organic substance, without being interfered with by the action of adsorbing the nitrite ion and the nitrate ion.

After providing the adsorbent in the process T100, the method soaks the adsorbent in the water for growth where the aquatic organism is grown (process T110). This process causes at least one of the bacterium and the organic substance included in the water for growth to be adsorbed to the adsorbent. The aquatic organism herein includes an aquatic plant and an aquatic microorganism, as well as an aquatic animal. For example, when the aquatic organism is fish, the water for growth where the aquatic organism is grown may be, for example, water in an aquaculture pond of fish. In aquaponics of combining fish culturing with hydroponic culture of a vegetable or the like, the water for growth where the aquatic organism is grown may be, for example, water in a fish culture tank or water in a cultivation water tank where hydroponic culture is performed using water supplied from the fish culture tank.

The water for growth of such an aquatic organism generally includes organic substances (including fragments containing the organic substances), such as excrement and carcasses of an aquatic organism (including dry plant bodies, when the aquatic organism is an aquatic plant). Furthermore, the water for growth of the aquatic organism generally includes organic matter-degrading bacteria. The water for growth of the aquatic organism accordingly includes organic substances of the smaller molecular weights and inorganic substances such as ammonia, which are produced by decomposition of the organic substances described above by the organic matter-degrading bacteria, as well as the organic substances described above. Moreover, when the aquatic organism is an aquatic animal, such as fish, the water for growth includes ammonia excreted from the aquatic animal. Furthermore, the water for growth of the aquatic organism generally includes nitrification bacteria, in addition to the organic matter-degrading bacteria described above. The nitrification bacteria include ammonia-oxidizing bacteria that oxidize ammonia to produce nitrous acid and nitrite-oxidizing bacteria that oxidize nitrous acid to produce nitric acid, and are present to float in the water for growth or to adhere to aquatic animals, aquatic plants and constructions. The water for growth of the aquatic organism accordingly further includes nitrous acid and nitric acid produced by the action of the nitrification bacteria. Soaking the adsorbent in the water for growth in the process T110 causes the bacteria such as the nitrification bacteria and the organic substances (including the fragments containing organic substances and organic substances produced by decomposition by the organic matter-degrading bacteria) in the water for growth to be adsorbed to the adsorbent.

The adsorbent may be configured to adsorb an inorganic substance, in addition to the bacterium and the organic substance described above, as the useful element contributing to promote the plant growth and, for example, may be configured to additionally adsorb at least one of ammonia, nitrous acid, and nitric acid described above. The adsorbent may also be configured to adsorb a substance that serves as a biostimulant included in the water for growth. The biostimulant is also called a biostimulation material and is known to act on the plant physiology, for example, by a route different from a route for nutrients and to promote the growth of a plant. The biostimulant may include bacteria and organic substances, such as amino acids, fatty acids, peptides, polysaccharides, and vitamins but may be another type of substance, for example, minerals.

After the adsorbent is soaked in the water for growth and the useful element, such as the bacterium and/or the organic substance described above, is adsorbed to the adsorbent in the process T110, the method takes out the adsorbent, which serves as the plant growth promoter, from the water for growth (process T120). In the process T120, as an indication to specify that a required amount of the useful element for exertion of the effects is adsorbed to the adsorbent, it is preferable that the concentration of nitrate ion in the water for growth which the adsorbent is soaked in (the concentration of nitrate ion in the water for growth when the adsorbent is taken out therefrom) is equal to or higher than 50 ppm.

For example, in the case of newly starting the growth of an aquatic animal, such as fish, excretion from the aquatic animal generally increases the concentration of ammonia in the water for growth. This causes growth of ammonia-oxidizing bacteria and causes a reaction of oxidizing ammonia to produce nitrous acid to proceed. This increases the concentration of nitrous acid in the water for growth, causes growth of nitrite-oxidizing bacteria and causes a reaction of oxidizing nitrous acid to produce nitric acid to proceed. Accordingly, as the ammonia-oxidizing bacteria and the nitrite-oxidizing bacteria are multiplied to stably function in the water for growth, the concentration of nitric acid gradually increases in the water for growth. As described above, the concentration of nitric acid in the water for growth serves as the indication that a sufficient amount of the nitrification bacterium is present in the water for growth and that the water for growth is stabilized. A certain high level of not lower than 50 ppm of the concentration of nitrate ion in the water for growth which the adsorbent is soaked in (the concentration of nitrate ion in the water for growth when the adsorbent is taken out therefrom) accordingly enables the useful element (for example, including the nitrification bacterium) in the water for growth in the state that a sufficient amount of the nitrification bacterium works, to be adsorbed to the adsorbent.

In order to produce the plant growth promoter by using the water for growth where a sufficient amount of the nitrification bacterium is present as described above, it is preferable to use the water for growth having an occupancy rate of 5% or higher of Rhizobiales. f (Rhizobiaceae) in a bacterial flora in the water for growth in environmental DNA analysis of the water for growth which the adsorbent is soaked in. It is also preferable to use the water for growth having an occupancy rate of 5% or higher of such a bacterial group that the result of Topic analysis of LEA (Latent-Environment Allocation) (latent environment allocation of microbial community data, PLoS Comput Biol. 2018: 14(6), e1006143) with regard to the bacterial flora in the water for growth, as the environmental DNA analysis of the water for growth which the adsorbent is soaked in, suggests the rhizosphere and endophyte of plants. The LEA (Latent-Environment Allocation) is configured to find the relationship between a structural pattern and an environmental pattern of a microbial community and is an interactive web application developed by applying a Corr-LDA model to a set of sample description by systematic composition and natural language with regard to tens of thousands of 16S rRNA gene amplicon samples and integrating results of learning.

In terms of ensuring an adsorption amount of useful components to the adsorbent, the soaking time until the adsorbent is taken out from the water for growth in the process T120 is preferably, for example, one day or longer, is more preferably two days or longer and is furthermore preferably three days or longer. Furthermore, the soaking time may be, for example, three weeks or shorter, may be two weeks or shorter, and may further be one week or shorter. The soaking of the adsorbent is preferably performed in such an environment that the organic substance, such as excrement of the aquatic animal, is accumulated in the water for growth, that aerobic or anaerobic microbial degradation proceeds, and that the nitrification bacterium acts as described above.

After the plant growth promoter is obtained by taking out the adsorbent from the water for growth in the process T120, the method applies the obtained plant growth promoter to a land plant to promote the growth of the plant (process T130). One method of applying the plant growth promoter to a plant is, for example, a method of applying the plant growth promoter to the soil used for growing the plant. The soil which the plant growth promoter is applied to may be, for example, soil for raising of seeding, culture soil, agricultural land (including agricultural land for plowing culture and agricultural land for non-plowing culture) or soil in a planting location other than the agricultural land. Another method of applying the plant growth promoter to a plant is a method of applying the plant growth promoter to a medium for hydroponic culture. The “hydroponic culture” herein includes both a method using a solid medium, such as hydro-balls, rock wool, or coco peat, instead of the soil (hydroculture) and a method of growing the plant by using only a culture solution as the medium with no use of the solid medium. In the case of application of the plant growth promoter, the hydroponic culture using the solid medium may use the plant growth promoter by being mixed in the solid medium. The hydroponic culture using only the culture solution may use the plant growth promoter by being added to the culture solution.

When the plant growth promoter is applied to the soil as described above or when the plant growth promoter is applied to the medium of hydroponic culture, the application amount of the plant growth promoter may be, for example, 1% by volume or higher and is preferably 10% by volume or higher to the soil, the solid medium, or the culture solution. Furthermore, the application amount of the plant growth promoter may be 100% by volume or lower and may further be 50% by volume or lower to the soil or the solid medium. In the description below, % by volume as the unit of the application amount of the plant growth promoter to the soil, the solid medium, or the culture solution is also referred to as v/v %.

The method of producing the plant growth promoter according to the embodiment having the configuration described above enables a useful element that has not conventionally been used for promoting the growth of a land plant and that includes, for example, a bacterium present in the water for growth as a water sphere and an organic substance deriving from an aquatic organism, to be obtained for the purpose of promoting the growth of the land plant by an extremely simple operation of soaking the adsorbent in the water for growth where the aquatic organism is grown. Application of the plant growth promoter produced as described above to a land plant enables the useful element that has not conventionally been used as described above, to be used for promoting the growth of the land plant. For example, the plant growth promoter of the embodiment may be applied to a land plant in a sprouting period or in an initial growth period that is some time after sprouting, so as to promote the growth of the plant in such a state.

It is thought that a bacterial group, such as a nitrification bacterial group involved in decomposition of ammonia and another microbial community of microorganisms grown under the effects of the nitrification bacterial group, in a water sphere like the water for growth of an aquatic organism is different from a bacterial group similarly involved in decomposition of ammonia and decomposition of organic substances in a land sphere like the soil where a land plant is grown. It is also thought that a useful element, such as an organic substance obtained from the water sphere, for example, an organic substance deriving from an aquatic organism, include different materials from materials included in a useful element, such as an organic substance in the compost obtained by using a material deriving from a land plant or a land animal. The use of the plant growth promoter produced by the method of producing the plant growth promoter of the embodiment enables the growth of the land plant to be promoted by using the useful element that is derived from the water sphere and that has not conventionally been used.

Furthermore, the configuration of the embodiment causes the bacterium and the organic substance to be adsorbed to the adsorbent by simply soaking the adsorbent in the water for growth where the aquatic organism is grown. This configuration reduces an increase in the amount of the bacterium and an increase in the amount of the organic substance in the water for growth by the simple operation and suppresses aquatic contamination of the water for growth. Moreover, when the adsorbent is configured by using the carbon material, applying the plant growth promoter, which is the adsorbent with the useful element adsorbed thereto, to the soil enables the adsorbent to be stably isolated in the soil as the carbon component that is not decomposed by soil microorganisms.

The present disclosure may be implemented by the following aspects:
(1) According to one aspect of the present disclosure, there is provided a method for producing a plant growth promoter. This method for producing the plant growth promoter comprises providing an adsorbent configured to adsorb at least one of a bacterium and an organic substance; soaking the adsorbent in water for growth where an aquatic organism is grown; and obtaining the adsorbent taken out from the water for growth, as the plant growth promoter.

The method for producing the plant growth promoter according to this aspect enables a useful element that has not conventionally been used for promoting the growth of a land plant and that includes, for example, a bacterium present in the water for growth as a water sphere and/or an organic substance derived from an aquatic organism, to be obtained for the purpose of promoting the growth of the land plant by an extremely simple operation of soaking the adsorbent in the water for growth where the aquatic organism is grown and subsequently taking out the adsorbent from the water for growth.
(2) In the method for producing the plant growth promoter of the above aspect, the adsorbent may be configured by using a carbon material or a biological organic material. When the plant growth promoter is used by being mixed with, for example, soil, the configuration of this aspect suppresses the adsorbent retained in the ground from adversely affecting the environment or the like. When the plant growth promoter is used by being mixed with, for example, the soil, the configuration of the adsorbent by using the carbon material enables carbon to be retained in the ground.
(3) In the method for producing the plant growth promoter of the above aspect, the adsorbent may be a porous or fibrous adsorbent. The configuration of this aspect readily provides the adsorbent having a high specific surface area. As a result, this enables the useful element derived from the water sphere for promoting the growth of the plant to be adsorbed to the surface of the adsorbent at a higher density.
(4) In the method for producing the plant growth promoter of the above aspect, water for growth having a concentration of nitrate ion of not lower than 50 ppm may be used as the water for growth which the adsorbent is soaked in. The configuration of this aspect enables the useful element included in the water for growth in the state that a sufficient amount of a nitrification bacterium works, to be adsorbed to the adsorbent.
(5) In the method for producing the plant growth promoter of the above aspect, soaking of the adsorbent in the water for growth may be performed for a time period of one day to one week. The configuration of this aspect readily ensures adsorption of a sufficient amount of the useful element to the adsorbent. Furthermore, although the soaking time of the adsorbent in the water for growth may further be increased, the soaking time of this aspect reduces the cost of producing the plant growth promoter.
(6) According to another aspect of the present disclosure, there is provided a method for growing a plant. This method for growing the plant comprises applying the plant growth promoter produced by the method described in one of the above aspects (1) to (5), to a land plant.

The method for growing the plant according to this aspect enables a useful element that has not conventionally been used for promoting the growth of a land plant and that includes, for example, a bacterium present in the water for growth as a water sphere and/or an organic substance derived from an aquatic organism, to be used for the plant growth promoter of the land plant.
(7) The method for growing the plant of the above aspect may further comprise applying the plant growth promoter to soil used for cultivation of the land plant. The configuration of this aspect enables the soil including a useful element that has not conventionally been used for promoting the growth of the land plant, to be used to promote the growth of the land plant.
(8) The method for growing the plant of the above aspect may further comprise applying the plant growth promoter to a medium used for hydroponic culture of the land plant. The configuration of this aspect enables the medium including a useful element that has not conventionally been used for promoting the growth of the land plant, to be used to promote the growth of the land plant.
(9) In the method for growing the plant of the above aspect, an amount of application of the plant growth promoter to the soil described above in (7) or to the medium described above in (8) may be not lower than 10% by volume and not higher than 50% by volume to the soil or to the medium. The configuration of this aspect readily promotes the growth of the land plant.

The present disclosure may be implemented by a variety of aspects other than those described above: for example, a method for transferring a useful element of promoting the growth of a plant from a water sphere to a land sphere.

### Examples

The following describes the present disclosure more specifically by referring to some examples. The present disclosure is, however, not limited to the description of these examples. In the examples described below, plant growth promoters were produced according to the method of producing the plant growth promoter described above with reference to FIG. 1 and were applied to a plant for a plant growth test. The results of the plant growth test are also shown below.

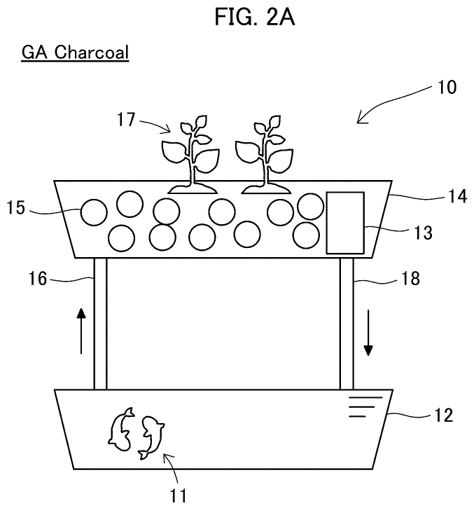

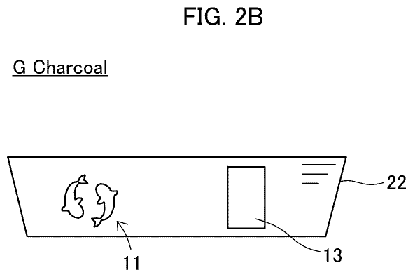

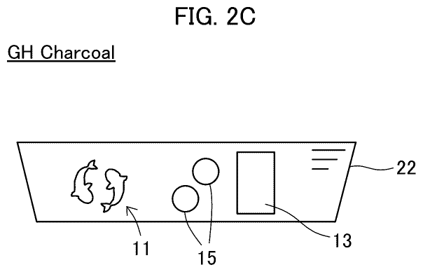

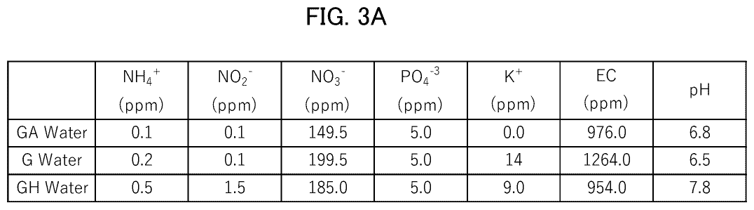

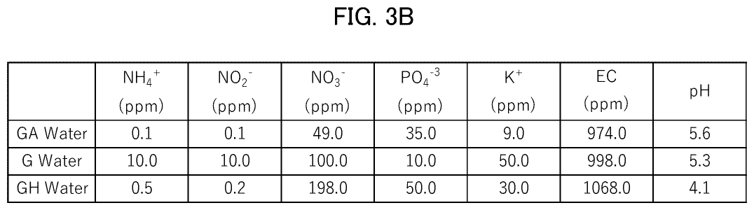

FIGS. 2A to 2C are explanatory diagrams schematically illustrating methods of producing three different plant growth promoters, GA charcoal, G charcoal, and GH charcoal, as examples of the plant growth promoter described in the embodiment. FIG. 3A and FIG. 3B are explanatory diagrams showing the properties of waters for growth in the case of producing the plant growth promoters by the methods shown in FIG. 2A to FIG. 2C. FIG. 3A shows the properties of the waters for growth at a start of soaking the adsorbent. FIG. 3B shows the properties of the waters for growth at an end of soaking the adsorbent. In FIG. 3A and FIG. 3B, the respective waters for growth used for production of the GA charcoal, the G charcoal and the GH charcoal are respectively expressed as GA water, G water, and GH water. FIG. 3A and FIG. 3B show the concentration of ammonium ion, the concentration of nitrite ion, the concentration of nitrate ion, the concentration of phosphate ion, the concentration of potassium ion, the electrical conductivity EC and pH as the properties of the respective waters for growth. A method of measuring the properties of the waters for growth will be described later.

### <Production of Plant Growth Promoters>

### (Production of GA Charcoal)

FIG. 2A is an explanatory diagram schematically illustrating a method of producing a plant growth promoter by soaking an adsorbent in the water for growth where an aquatic organism is grown. The plant growth promoter produced by the method shown in FIG. 2A is called “GA charcoal” hereinafter. For the purpose of producing the GA charcoal as the plant growth promoter, in an aquaponics system 10 of combining fish culturing with hydroponic culture of a vegetable or the like, the water for growth was water in a cultivation water tank for hydroponic culture using water supplied from a fish culture tank. The aquaponics system 10 shown in FIG. 2A includes a fish culture tank 12 configured to farm fish as an aquatic organism 11; a cultivation water tank 14 configured to perform hydroponic culture by using water supplied from the fish culture tank 12; a first circulation flow path 16 configured to supply water from the fish culture tank 12 to the cultivation water tank 14; and a second circulation flow path 18 configured to supply water from the cultivation water tank 14 to the fish culture tank 12. In the aquaponics system 10, water is circulated between the fish culture tank 12 and the cultivation water tank 14 via the first circulation flow path 16 and the second circulation flow path 18. The excrement from the fish and the like are degraded by microorganisms in the fish culture tank 12, and degradation products obtained are supplied as nutrients to the cultivation water tank 14, so that a plant 17 is grown in the cultivation water tank 14.

The aquaponics system 10 used for producing the GA charcoal as the plant growth promoter was configured by using a medium-size aquaponics hydroponic culture DIY kit manufactured by AQUPONI Inc. “Binchotan” charcoal (particle diameter of 5 mm) manufactured by Sakura Sangyo Co., Ltd. was used as an adsorbent 13. In a lower water tank (the fish culture tank 12) of the aquaponics DIY kit, Wakin goldfish having a total weight of 400 g were bred as the aquatic animal 11. In an upper water tank (the cultivation water tank 14), hydro-balls were placed as media 15 to perform hydroponic culture of basil as the plant 17. As the fish culture tank 12 was subjected to aeration, the water in the fish culture tank 12 was continuously pumped up to be supplied to the cultivation water tank 14. The water in the cultivation water tank 14 freely fell to be circulated to the fish culture tank 12. The water level in the cultivation water tank 14 was regularly raised and lowered by the principle of siphon. Feeding was performed by an amount of 4 g/day. In the water of the cultivation water tank 14, 100 g of the adsorbent (charcoal) was soaked. The timing of soaking was determined according to the properties of the water for growth (the water in the cultivation water tank 14) as the indication. Soaking was started in the state of 0.1 ppm of ammonium ion, 0.1 ppm of nitrite ion, and 149.5 ppm of nitrate ion (shown in FIG. 3A) and was continued for one week. The adsorbent (charcoal) was then collected from the water for growth and was naturally dried to provide the GA charcoal. The properties of the water for growth (the water in the cultivation water tank 14) at the timing of collection of the adsorbent are shown in FIG. 3B.

### (Production of G Charcoal)

FIG. 2B is an explanatory diagram schematically illustrating another example of producing a plant growth promoter by soaking an adsorbent in the water for growth where an aquatic organism is grown. The plant growth promoter produced by the method shown in FIG. 2B is called “G charcoal” hereinafter. For the purpose of producing the G charcoal as the plant growth promoter, water in a water tank for farming fish (a water tank 22 shown in FIG. 2B) was used as the water for growth.

A 16 L rectangular basin manufactured by Suzuki Seisakusho was used for the water tank 22. “Binchotan” charcoal (particle diameter of 5 mm) manufactured by Sakura Sangyo Co., Ltd. was used as an adsorbent 13. In the water tank 22, Wakin goldfish having a total weight of 100 g were introduced as the aquatic organism 11. Feeding was performed by an amount of 2 g/day. In the water of the water tank 22, 100 g of the adsorbent (charcoal) was soaked. The timing of soaking was determined according to the properties of the water for growth (the water in the water tank 22) as the indication. Soaking was started in the state of 0.2 ppm of ammonium ion, 0.1 ppm of nitrite ion, and 199.5 ppm of nitrate ion and was continued for one week. The adsorbent (charcoal) was then collected from the water for growth and was naturally dried to provide the G charcoal. The properties of the water for growth (the water in the water tank 22) at the timing of collection of the adsorbent are shown in FIG. 3B.

### (Production of GH Charcoal)

FIG. 2C is an explanatory diagram schematically illustrating another example of producing a plant growth promoter by soaking an adsorbent in the water for growth where an aquatic organism is grown. The plant growth promoter produced by the method shown in FIG. 2C is called “GH charcoal” hereinafter. For the purpose of producing the GH charcoal as the plant growth promoter, water in a water tank for farming fish (a water tank 22 shown in FIG. 2C) was used as the water for growth. The method of producing the GH charcoal is, however, different from the method of producing the G charcoal shown in FIG. 2B by addition of hydro-balls as the media 15 used in the cultivation water tank 14 of the aquaponics system 10 shown in FIG. 2A.

A 16 L rectangular basin manufactured by Suzuki Seisakusho was used for the water tank 22. “Binchotan” charcoal (particle diameter of 5 mm) manufactured by Sakura Sangyo Co., Ltd. was used as an adsorbent 13. In the water tank 22, Wakin goldfish having a total weight of 100 g were introduced as the aquatic organism 11, and 700 g of hydro-balls used in the cultivation water tank 14 of the aquaponics system 10 shown in FIG. 2A were soaked. Feeding was performed by an amount of 2 g/day, and the water tank was subjected to aeration. In the water of the water tank 22, 100 g of the adsorbent (charcoal) was soaked. The timing of soaking was determined according to the properties of the water for growth (the water in the water tank 22) as the indication. Soaking was started in the state of 0.5 ppm of ammonium ion, 1.5 ppm of nitrite ion, and 185.0 ppm of nitrate ion and was continued for one week. The adsorbent (charcoal) was then collected from the water for growth and was naturally dried to provide the GH charcoal. The properties of the water for growth (the water in the water tank 22) at the timing of collection of the adsorbent are shown in FIG. 3B.

### (Measurement Method of Water Properties)

The concentration of ammonium ion, the concentration of nitrite ion, the concentration of nitrate ion and the concentration of phosphate ion were measured by a colorimetric method using a pack test manufactured by KYORITSU CHEMICAL-CHECK Lab., Corp. The concentration of potassium ion was measured by an ion electrode method using a compact potassium ion meter manufactured by HORIBA Ltd. The electrical conductivity EC was measured by using a compact electrical conductivity meter manufactured by HORIBA Ltd, and pH was measured by a glass electrode method.

### <Production of Other Mixed Materials>

The procedure of the plant growth test also produced different types of mixed materials, in addition to the GA charcoal, the G charcoal, and the GH charcoal described above as the examples corresponding to the plant growth promoter of the embodiment, and made a comparison of these different types of mixed materials with the above examples of the plant growth promoter. The following describes “Hy charcoal” and “Cw charcoal” produced as the different types of mixed materials.

### (Production of Hy Charcoal)

The Hy charcoal was produced by using “Binchotan” charcoal (particle diameter of 5 mm) manufactured by Sakura Sangyo Co., Ltd. as an adsorbent, causing a liquid fertilizer (HYPONeX 6-10-5 manufactured by HYPONeX JAPAN Ltd.) to be decomposed into components, and causing the components to be adsorbed to this adsorbent. An operation of adsorption used Easy Ponics manufactured by Kotobuki Kogei Co., Ltd. to connect a lower water tank with an upper water tank and to circulate water between the lower water tank and the upper water tank by means of a submersible pump placed in the lower water tank. The operation of adsorption placed 6 L of water (well water) in the lower water tank and 100 g of the above adsorbent in the upper water tank, added 10 mL of HYPONeX to the upper water tank, and operated this system for two weeks. The adsorbent (charcoal) was then collected from the upper water tank and was naturally dried to provide the Hy charcoal.

### (Cw Charcoal)

The Cw charcoal was produced by using “Binchotan” charcoal (particle diameter of 5 mm) manufactured by Sakura Sangyo Co., Ltd. as an adsorbent, causing pellets of cattle manure compost (organic Agret 825eco manufactured by ASAHI AGRIA CO., LTD.) to be decomposed into components, and causing the components to be adsorbed to this adsorbent. An operation of adsorption used Easy Ponics manufactured by Kotobuki Kogei Co., Ltd. to connect a lower water tank with an upper water tank and to circulate water between the lower water tank and the upper water tank by means of a submersible pump placed in the lower water tank. The operation of adsorption placed 6 L of water (well water) in the lower water tank and 100 g of the above adsorbent in the upper water tank, added 10 g of the pellets of cattle manure compost to the upper water tank, and operated this system for two weeks. The adsorbent (charcoal) was then collected from the upper water tank and was naturally dried to provide the Cw charcoal.

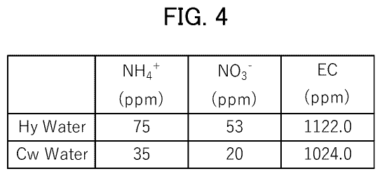

FIG. 4 shows the properties of the waters circulated in the water tanks at the end of soaking of the adsorbent in the processes of producing the Hy charcoal and the Cw charcoal described above. FIG. 4 shows the measurement results of the concentration of ammonium ion, the concentration of nitrate ion, and the electrical conductivity EC. Measurement methods employed are similar to those described above with regard to FIG. 3A and FIG. 3B. In FIG. 4, the waters in the water tanks at the end of soaking of the adsorbent in the processes of producing the Hy charcoal and the Cw charcoal are respectively expressed as Hy water and Cw water.

### <Conditions of Plant Growth Test>

A growth test of plant bodies was performed by applying a variety of mixed materials, such as the GA charcoal, the G charcoal and the GH charcoal described above, to the soil. The growth test used commercially available culture soils, blended the variety of mixed materials, such as the GA charcoal, the G charcoal, and the GH charcoal, with the commercially available culture soils to prepare test culture soils, sowed seeds of a plant in the prepared respective test culture soils, and cultivated the plant. The commercially available culture soils used were iron-rich culture soil No. 1 manufactured by Biwako Sangyo Co., Ltd. (hereinafter referred to as “unmixed culture soil 1”) and Super Mix A manufactured by Sakata Seed Corporation (hereinafter referred to as “unmixed culture soil 2”). The seeds of the plant used were Japanese mustard spinach (Yume Wakana Komatsuna (F1) by Nakahara Seed Product Co., Ltd.) Test culture soils were prepared by mixing the commercially available culture soils described above with plant growth promoters, adsorbents, fertilizers and the like. Each of the test culture soils obtained was filled in a 128-hole cell tray. Two seeds were then sowed in each of the cells filled with the test culture soil, and cultivation was started with supply of water from a bottom face of the cell tray. When the water for growth, a liquid fertilizer and the like were to be supplied, a predetermined amount of the water for growth, the liquid fertilizer and the like were supplied in the process of supplying water from the bottom face of the cell tray. The conditions of cultivation were constant temperature control to 24 °C, duration of a light condition for 12 hours, and an illumination intensity of 10,000 LUX. After elapse of 12 days since seeding, when true leaves come out, the plant growth test compared the plant postures (appearances) or the raw weights of overground parts of the respective test culture soils.

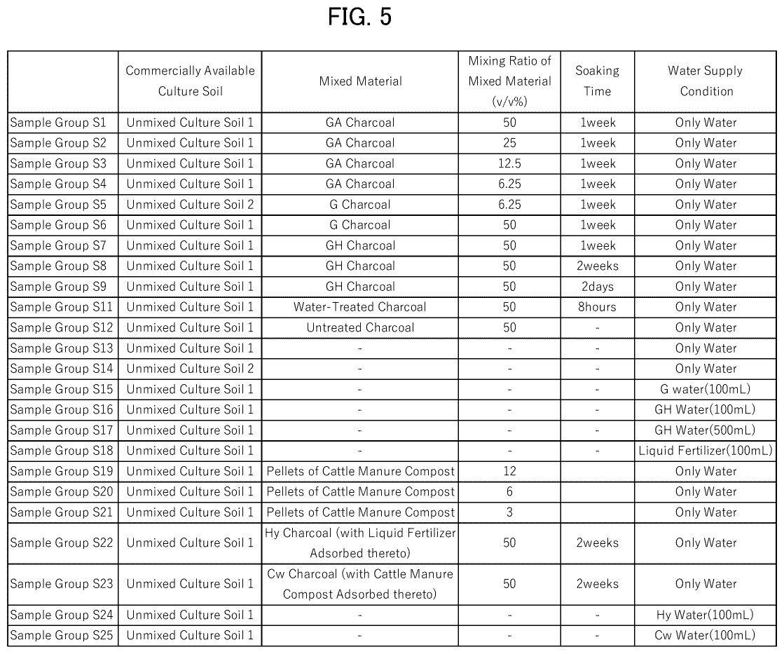

FIG. 5 is an explanatory diagram collectively showing test conditions of respective sample groups in the plant growth test. FIG. 5 shows a type of the commercially available culture soil used, a type of the mixed material added to the commercially available culture soil, a mixing ratio of the mixed material to the commercially available culture soil, a time period during which an adsorbent is soaked in a liquid for adsorption to produce the mixed material (hereinafter referred to as “soaking time”) and a water supply condition in the plant growth test. The following describes the conditions of the plant growth test with regard to respective sample groups with reference to FIG. 5. The mixed materials used in sample groups S1 to S9 correspond to the plant growth promoters described in the embodiment. Sample groups S11 to S25 are sample groups of comparative examples.

### (Sample Group S1)

The sample group S1 used the unmixed culture soil 1 as the commercially available culture soil, used the GA charcoal as the mixed material, and had the mixing ratio of the mixed material set to 50 v/v %. The water supply condition was supplying water from the bottom face of the cell tray. This water supply condition is shown as “only water” in FIG. 5.

### (Sample Group S2)

The sample group S2 used the unmixed culture soil 1 as the commercially available culture soil, used the GA charcoal as the mixed material, and had the mixing ratio of the mixed material set to 25 v/v %. The water supply condition was supplying water from the bottom face of the cell tray.

### (Sample Group S3)

The sample group S3 used the unmixed culture soil 1 as the commercially available culture soil, used the GA charcoal as the mixed material, and had the mixing ratio of the mixed material set to 12.5 v/v %. The water supply condition was supplying water from the bottom face of the cell tray.

### (Sample Group S4)

The sample group S4 used the unmixed culture soil 1 as the commercially available culture soil, used the GA charcoal as the mixed material, and had the mixing ratio of the mixed material set to 6.25 v/v %. The water supply condition was supplying water from the bottom face of the cell tray.

### (Sample Group S5)

The sample group S5 was subjected to the test under similar conditions to those of the sample group S1, except using the unmixed culture soil 2 as the commercially available culture soil, using the G charcoal as the mixed material and having the mixing ratio of the mixed material set to 6.25 v/v %.

### (Sample Group S6)

The sample group S6 was subjected to the test under similar conditions to those of the sample group S1, except using the G charcoal as the mixed material.

### (Sample Group S7)

The sample group S7 was subjected to the test under similar conditions to those of the sample group S1, except using the GH charcoal as the mixed material.

### (Sample Group S8)

The sample group S8 was subjected to the test under similar conditions to those of the sample group S1, except using, as the mixed material, the GH charcoal having the soaking time of two weeks in the process of producing the mixed material.

### (Sample Group S9)

The sample group S9 was subjected to the test under similar conditions to those of the sample group S1, except using, as the mixed material, the GH charcoal having the soaking time of two days in the process of producing the mixed material.

### (Sample Group S11)

The sample group S11 was subjected to the test under similar conditions to those of the sample group S1, except using, as the mixed material, a mixed material (water-treated charcoal) produced by soaking 100 g of the adsorbent in 10 L of water and leaving the adsorbent for eight hours.

### (Sample Group S12)

The sample group S12 was subjected to the test under similar conditions to those of the sample group S1, except using, as the mixed material, an adsorbent without a soaking process (untreated charcoal).

### (Sample Group S13)

The sample group S13 used the test culture soil composed of only the unmixed culture soil 1 with no use of the mixed material and had the water supply condition of “only water” like the sample group S1.

### (Sample Group S14)

The sample group S14 used the test culture soil composed of only the unmixed culture soil 2 with no use of the mixed material and had the water supply condition of “only water” like the sample group S1.

### (Sample Group S15)

The sample group S15 used the test culture soil composed of only the unmixed culture soil 1 like the sample group S13. Furthermore, the sample group S15 had the water supply condition of supplying 100 mL of the G water at the end of soaking having the properties shown in FIG. 3B from a bottom face of a cell tray after seeding and after that, appropriately supplying water from the bottom face.

### (Sample Group S16)

The sample group S16 used the test culture soil composed of only the unmixed culture soil 1 like the sample group S13. Furthermore, the sample group S16 had the water supply condition of supplying 100 mL of the GH water at the end of soaking having the properties shown in FIG. 3B from a bottom face of a cell tray after seeding and after that, appropriately supplying water from the bottom face.

### (Sample Group S17)

The sample group S17 used the test culture soil composed of only the unmixed culture soil 1 like the sample group S13. Furthermore, the sample group S17 had the water supply condition of supplying 100 mL of the GH water at the end of soaking having the properties shown in FIG. 3B from a bottom face of a cell tray after seeding and after that, appropriately supplying the GH water from the bottom face. As a result, a total of 500 mL of the GH water was supplied.

### (Sample Group S18)

The sample group S18 used the test culture soil composed of only the unmixed culture soil 1 like the sample group S13. Furthermore, the sample group S18 had the water supply condition of supplying a 500-fold diluted solution of a liquid fertilizer (HYPONeX 6-10-5 manufactured by HYPONeX JAPAN Ltd.) from a bottom face of a cell tray after seeding and after that, appropriately supplying water from the bottom face.

### (Sample Group S19)

The sample group S19 was subjected to the test under similar conditions to those of the sample group S1, except using pellets of cattle manure compost (organic Agret 825eco manufactured by ASAHI AGRIA CO., LTD.) as the mixed material and having a mixing ratio of the mixed material to the unmixed culture soil 1 as the commercially available culture soil set to 12 v/v %.

### (Sample Group S20)

The sample group S20 was subjected to the test under similar conditions to those of the sample group S1, except using pellets of cattle manure compost (organic Agret 825eco manufactured by ASAHI AGRIA CO., LTD.) as the mixed material and having a mixing ratio of the mixed material to the unmixed culture soil 1 as the commercially available culture soil set to 6 v/v %.

### (Sample Group S21)

The sample group S21 was subjected to the test under similar conditions to those of the sample group S1, except using pellets of cattle manure compost (organic Agret 825eco manufactured by ASAHI AGRIA CO., LTD.) as the mixed material and having a mixing ratio of the mixed material to the unmixed culture soil 1 as the commercially available culture soil set to 3 v/v %.

### (Sample Group S22)

The sample group S22 was subjected to the test under similar conditions to those of the sample group S1, except using the Hy charcoal as the mixed material.

### (Sample Group S23)

The sample group S23 was subjected to the test under similar conditions to those of the sample group S1, except using the Cw charcoal as the mixed material.

### (Sample Group S24)

The sample group S24 used the test culture soil composed of only the unmixed culture soil 1 like the sample group S13. Furthermore, the sample group S24 had the water supply condition of supplying 100 mL of the Hy water shown in FIG. 4 from a bottom face of a cell tray after seeding and after that, appropriately supplying water from the bottom face.

### (Sample Group S25)

The sample group S25 used the test culture soil composed of only the unmixed culture soil 1 like the sample group S13. Furthermore, the sample group S25 had the water supply condition of supplying 100 mL of the Cw water shown in FIG. 4 from a bottom face of a cell tray after seeding and after that, appropriately supplying water from the bottom face.

### <Results of Plant Growth Test>

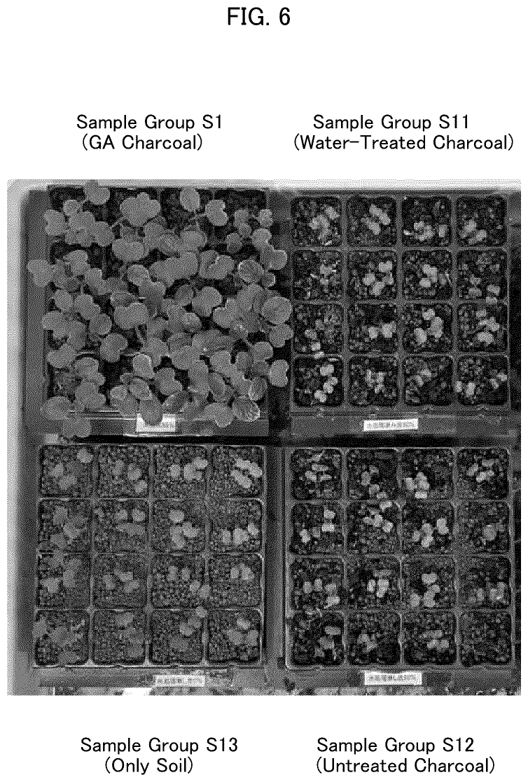

FIG. 6 is an explanatory diagram showing the results of the plant growth test or more specifically showing the plant posture (appearance) after elapse of 12 days since seeding, with regard to the sample group S1 (with use of the GA charcoal as the mixed material), the sample group S11 (with use of the water-treated charcoal as the mixed material), the sample group S12 (with use of the untreated charcoal as the mixed material), and the sample group S13 (with use of only the soil). As shown in FIG. 6, the growth of the overground part was significantly promoted in the sample group S1, compared with in the sample groups S11 to S13.

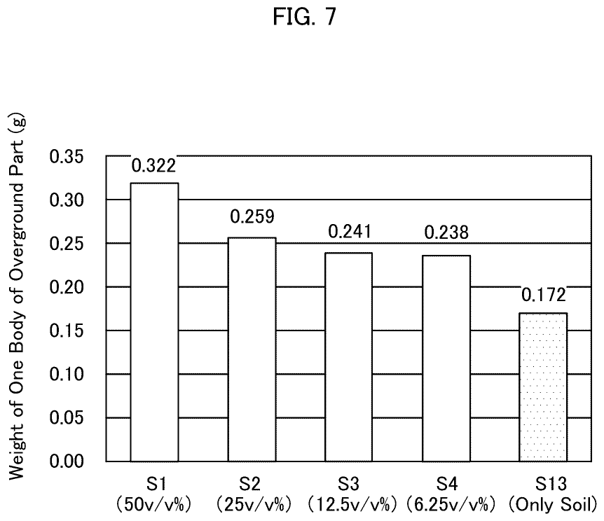

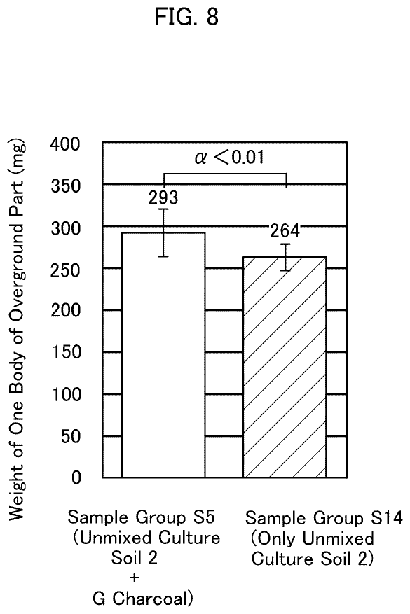

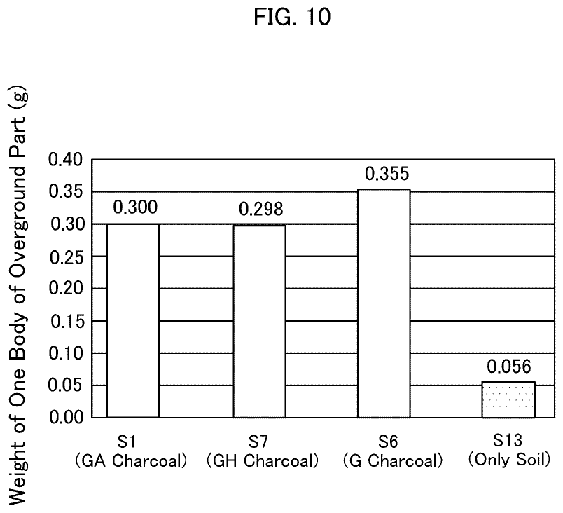

FIG. 7 is an explanatory diagram showing the results of the plant growth test or more specifically showing the measurement results of the raw weight of the overground part after elapse of 12 days since seeding, with regard to the sample groups S1, S2, S3 and S4 (all with use of the GA charcoal as the mixed material) and the sample group S13 (with use of only the soil). All the sample groups S1, S2, S3 and S4 had low risk rates a of less than 0.01, compared with the sample group S13. As shown in FIG. 7, the growth of the overground part was promoted in all the sample groups S1, S2, S3 and S4, compared with in the sample group S13. FIG. 7, as well as FIG. 8, FIGS. 10 to 14, FIG. 16, FIG. 18 and FIG. 19 described later show the raw weight of the overground part in the respective sample groups subjected to the plant growth test. Each of these values shows an average value of the weight per one body in measurement of N=10.

As described above, it has been confirmed that the useful plant growth promoter that promotes the initial growth of a plant is obtained by soaking the adsorbent in the water for growth where the aquatic organism is grown. In other words, it has been confirmed that the useful element of promoting the growth of the plant is transferred from the water sphere where the aquatic organism is grown to the land sphere where the land plant is grown. It has also been confirmed that such a useful plant growth promoter is obtainable even when the soaking time of the adsorbent in the water for growth where the aquatic organism is grown is a relatively short time period of one week. The growth promoting effect has been confirmed when the mixing ratio of the plant growth promoter to the soil is 6.25% by volume or higher. A high mixing ratio of 50% by volume shows the growth promoting effect and does not interfere with the growth. It has accordingly been confirmed that a large mass of the plant growth promoter using the carbon material as the adsorbent is applicable to the agricultural land for the purpose of storing carbon.

FIG. 8 is an explanatory diagram showing the results of the plant growth test or more specifically showing the measurement results of the raw weight of the overground part after elapse of 12 days since seeding, with regard to the sample group S5 (with use of the unmixed culture soil 2+6.25 v/v % of the G charcoal) and the sample group S14 (with use of only the unmixed culture soil 2). FIG. 8 shows average values as described above, with standard deviations shown by error bars. The unmixed culture soil 2 (Super Mix A manufactured by Sakata Seed Corporation) used in the sample group S5 and the sample group S14 uses black peat moss as the raw material and contains a more abundance of humus obtained by decomposition and transformation of the excrement of soil microorganisms and carcasses of animals and plants by the action of microorganisms and also includes essential fertilizer components required for the initial growth of the plant, compared with the unmixed culture soil 1.

The sample group S5 with use of the unmixed culture soil 2 and the G charcoal added thereto had the risk rate a of less than 0.01 and promoted the growth of the overground part by 15%, compared with the sample group S14 with use of only the unmixed culture soil 2. As described above, the plant growth promoter obtained by soaking the adsorbent in the water for growth where the aquatic microorganism is grown further promoted the initial growth of the plant, even when this plant growth promoter was applied to the soil having fertilizer components required for the initial growth. Accordingly, it is thought that the plant growth promoter of the present disclosure is industrially remarkably useful.

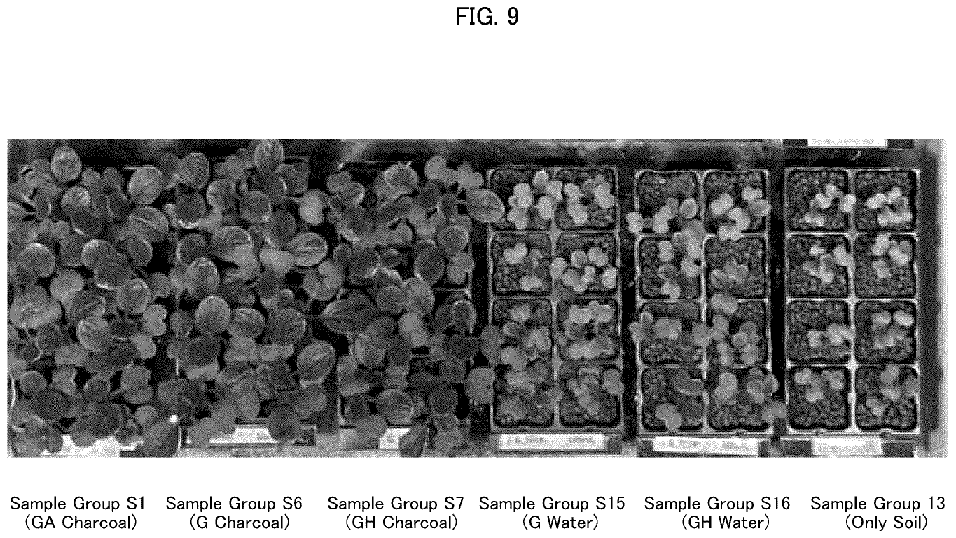

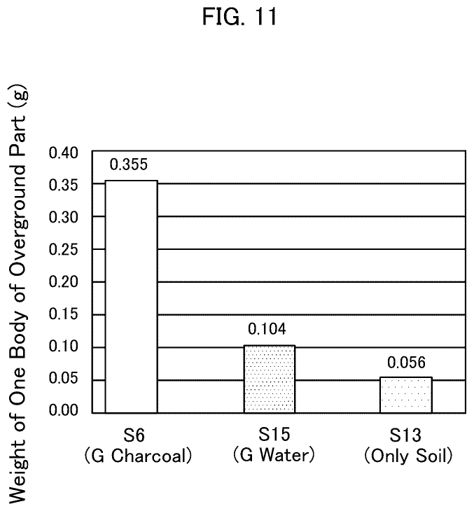

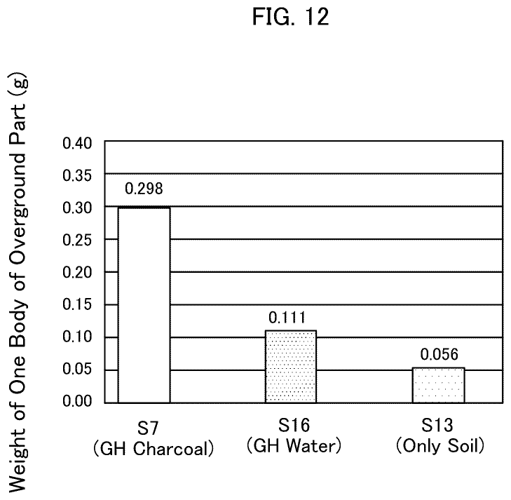

FIG. 9 is an explanatory diagram showing the results of the plant growth test or more specifically showing the plant posture (appearance) after elapse of 12 days since seeding, with regard to the sample group S1 (with use of the GA charcoal as the mixed material), the sample group S6 (with use of the G charcoal as the mixed material), the sample group S7 (with use the GH charcoal as the mixed material), the sample group S15 (with supply of the G water and no use of the mixed material), the sample group S16 (with supply of the GH water and no use of the mixed material), and the sample group S13 (with use of only the soil). FIG. 10 is an explanatory diagram showing the results of the plant growth test or more specifically showing the measurement results of the raw weight of the overground part after elapse of 12 days since seeding, with regard to the sample group S1 (with use of the GA charcoal as the mixed material), the sample group S6 (with use of the G charcoal as the mixed material), the sample group S7 (with use of the GH charcoal as the mixed material), and the sample group S13 (with use of only the soil). FIG. 11 is an explanatory diagram showing the results of the plant growth test or more specifically showing the measurement results of the raw weight of the overground part after elapse of 12 days since seeding, with regard to the sample group S6 (with use of the G charcoal as the mixed material), the sample group S15 (with supply of the G water and no use of the mixed material), and the sample group S13 (with use of only the soil). FIG. 12 is an explanatory diagram showing the results of the plant growth test or more specifically showing the measurement results of the raw weight of the overground part after elapse of 12 days since seeding, with regard to the sample group S7 (with use of the GH charcoal as the mixed material), the sample group S16 (with supply of the GH water and no use of the mixed material), and the sample group S13 (with use of only the soil).

As shown in FIG. 9 and FIG. 10, it has been confirmed that applying each of the plant growth promoters (S1, S6 and S7) obtained by soaking the adsorbent in the water for growth where the aquatic organism is grown, to the soil promotes the growth of the plant, compared with the case of using only the soil (S13). Among these plant growth promoters, the sample group S6 (the G charcoal was used) has the highest effect of promoting the growth.

As shown in FIG. 9 and FIG. 11, the sample group S15 with supply of the water which the G charcoal was soaked in (the G water) promoted the growth of the plant, compared with the case of using only the soil (S13). The growth promoting effect of the sample group S15 was, however, less than the effect of the sample group S6 with use of the G charcoal. Similarly, as shown in FIG. 9 and FIG. 12, the sample group S16 with supply of the water which the GH charcoal was soaked in (the GH water) promoted the growth of the plant, compared with the case of using only the soil (S13). The growth promoting effect of the sample group S16 was, however, less than the effect of the sample group S7 with use of the GH charcoal. These results suggest that the useful element in the water for growth where the aquatic organism is grown, is adsorbed to the adsorbent to be concentrated.

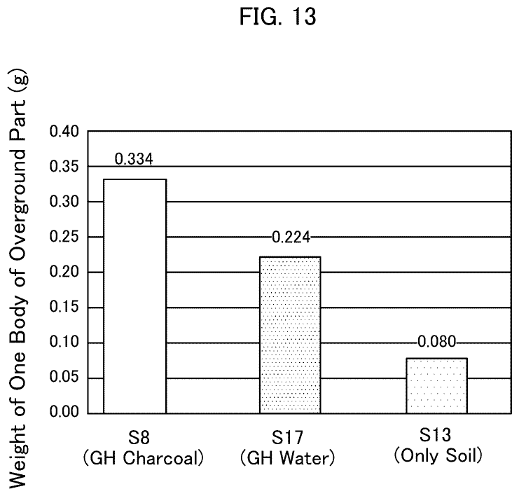

FIG. 13 is an explanatory diagram showing the results of the plant growth test or more specifically showing the measurement results of the raw weight of the overground part after elapse of 12 days since seeding, with regard to the sample group S8 (with use of the GH charcoal as the mixed material), the sample group S17 (with supply of the GH water and no use of the mixed material), and the sample group S13 (with use of only the soil). The sample group S8 has the longer soaking time of the adsorbent than the soaking time of the sample group S7 similarly with use of the HG charcoal as the mixed material. Furthermore, the sample group S17 significantly increases the supply amount of the GH water from 100 mL to 500 mL, compared with the sample group S16 similarly with supply of the GH water. As shown in FIG. 13, even when the useful element in the soil was concentrated to the limit by increasing the supply amount of the GH water containing the useful element, the growth promoting effect in this case was less than the effect in the case of using the GH charcoal with the useful element adsorbed to the adsorbent. These results suggest that the transfer of the useful element by adsorption to the adsorbent achieves promotion of the growth more efficiently and more simply, compared with the case of increasing the supply amount of the water for growth where the aquatic organism is grown.

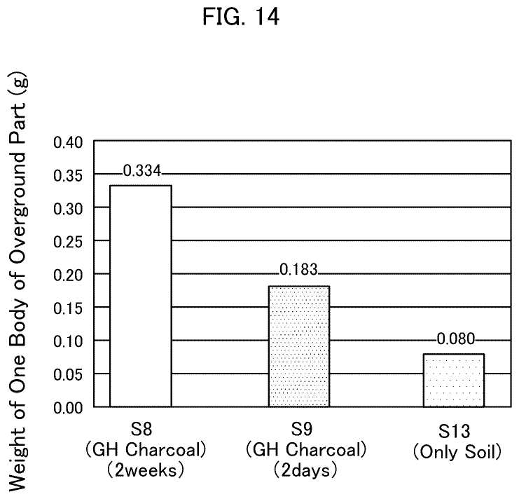

FIG. 14 is an explanatory diagram showing the results of the plant growth test or more specifically showing the measurement results of the raw weight of the overground part after elapse of 12 days since seeding, with regard to the sample group S8 (with use of the GH charcoal as the mixed material; the soaking time of two weeks), the sample group S9 (with use of the GH charcoal as the mixed material; the soaking time of two days), and the sample group S13 (with use of only the soil). As shown in FIG. 14, even shortening the soaking time, when the adsorbent is soaked in the water for growth where the aquatic organism is grown, to two days still promotes the growth of the plant compared with the case of using only the soil (S13), although the growth promoting effect in this case is less than the effect in the case having the soaking time of two weeks. These results suggest that the useful element can be sufficiently transferred from the water sphere to the land sphere.

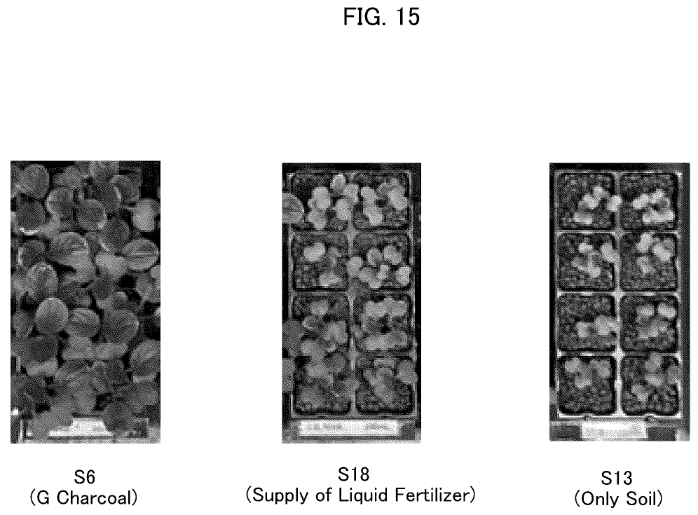

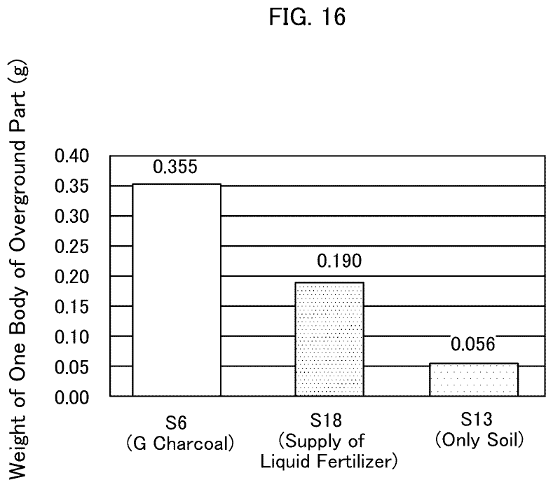

FIG. 15 is an explanatory diagram showing the results of the plant growth test or more specifically showing the plant posture (appearance) after elapse of 12 days since seeding, with regard to the sample group S6 (with use of the G charcoal as the mixed material), the sample group S18 (with supply of a liquid fertilizer and no use of the mixed material), and the sample group S13 (with use of only the soil). FIG. 16 is an explanatory diagram showing the results of the plant growth test or more specifically showing the measurement results of the raw weight of the overground part after elapse of 12 days since seeding, with regard to the sample group S6 (with use of the G charcoal as the mixed material), the sample group S18 (with supply of a liquid fertilizer and no use of the mixed material), and the sample group S13 (with use of only the soil).

As shown in FIG. 15 and FIG. 16, the sample group S18 with supply of the liquid fertilizer had the greater effect of promoting the plant growth, compared with the case of using only the soil (S13). The plant growth effect in this case was, however, less than the effect in the sample group S6 with use of the plant growth promoter of the present disclosure (the G charcoal). This means that the sample group with use of the plant growth promoter of the present disclosure (the G charcoal) has the greater effect of promoting the plant growth than the effect of the general inorganic fertilizer. For example, as described in PTL 1 and PTL 2, it is thought that the use of a carbide or the like as the adsorbent has difficulty in adsorption of inorganic nitrogen, such as nitrite ion and nitrate ion, to the adsorbent without making a special treatment for, for example, providing the anion exchange capacity. The respective sample groups of the examples use the adsorbent (“Binchotan” charcoal) without such a special treatment for proving the ion exchange capacity. It is thus thought that the useful elements transferred from the water sphere to the land sphere by the plant growth promoters of the respective sample groups S1 to S9 including the sample group 3 are different from the inorganic nitrogen, such as nitrite ion and nitrate ion. More specifically, it is thought that the transferred useful elements are bacteria growing on the adsorbent and organic components (organic fertilizer components and other biostimulants) readily adhering to the charcoal material.

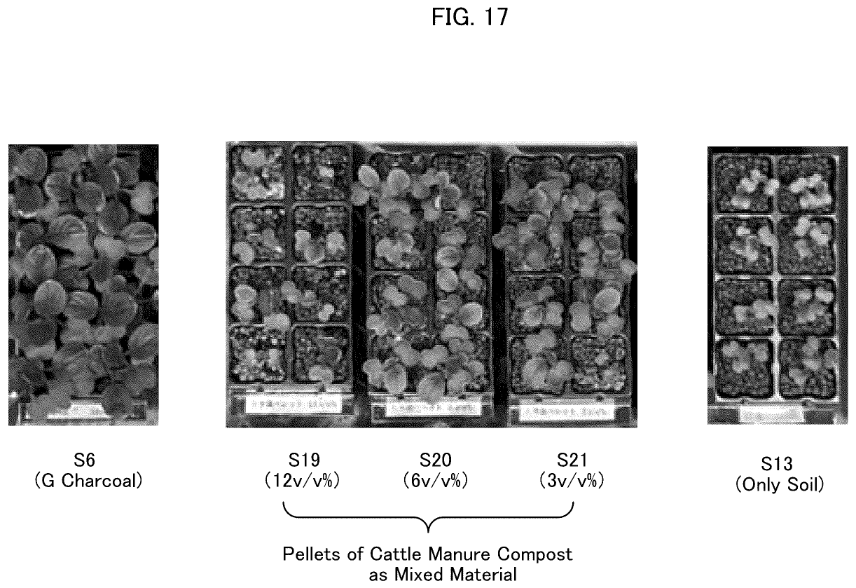

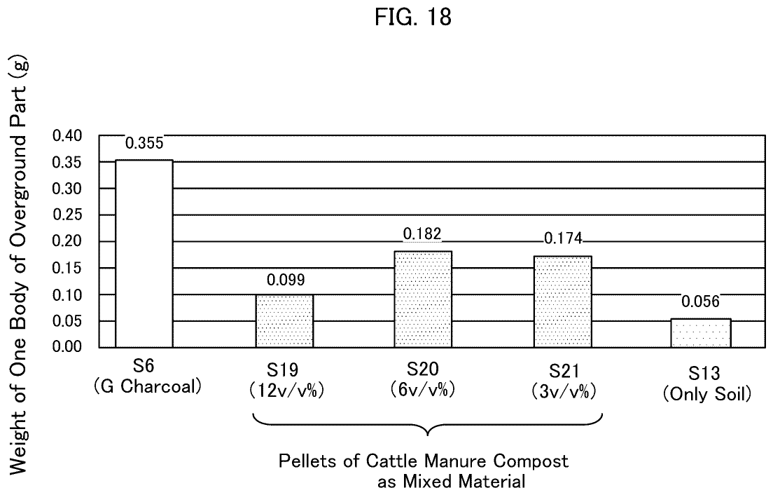

FIG. 17 is an explanatory diagram showing the results of the plant growth test or more specifically showing the plant posture (appearance) after elapse of 12 days since seeding, with regard to the sample group S6 (with use of the G charcoal as the mixed material), the sample group S19 (with use of the pellets of cattle manure compost as the mixed material; the mixing ratio of 6 v/v %), the sample group S21 (with use of the pellets of cattle manure compost as the mixed material; the mixing ratio of 3 v/v %), and the sample group S13 (with use of only the soil). FIG. 18 is an explanatory diagram showing the measurement results of the raw weight of the overground part after elapse of 12 days since seeding, with regard to the sample group S6, the sample group S19, the sample group S20, the sample group S21, and the sample group S13 described above.

As shown in FIG. 17 and FIG. 18, the sample groups S19 to S21 with use of the pellets of cattle manure compost as the mixed material had the better effects of promoting the plant growth, compared with the case of using only the soil (S13). Increasing the concentration of the pellets of cattle manure compost in the test culture soil, however, increased the number of plant bodies having a problem called “excessive fertilization”. The effects of promoting the plant growth in the sample groups S19 to S21 were less than the effect of promoting the plant growth in the sample group S6 (G charcoal) using the plant growth promoter according to the present disclosure. This may be ascribed to, for example, the problem caused by excessive fertilization described above or the like and the insufficient progress of degradation of organic substances by bacteria in the culture soil within a growth time period. These results show that using the plant growth promoter produced by soaking the adsorbent in the water for growth where an aquatic organism is grown ensures a sufficient application amount for the growth of a plant, while suppressing the occurrence of the above problem and has an extremely high effect of promoting the plant growth at least in an initial growth period after sprouting, compared with the case of using a conventionally known organic compost or the like.

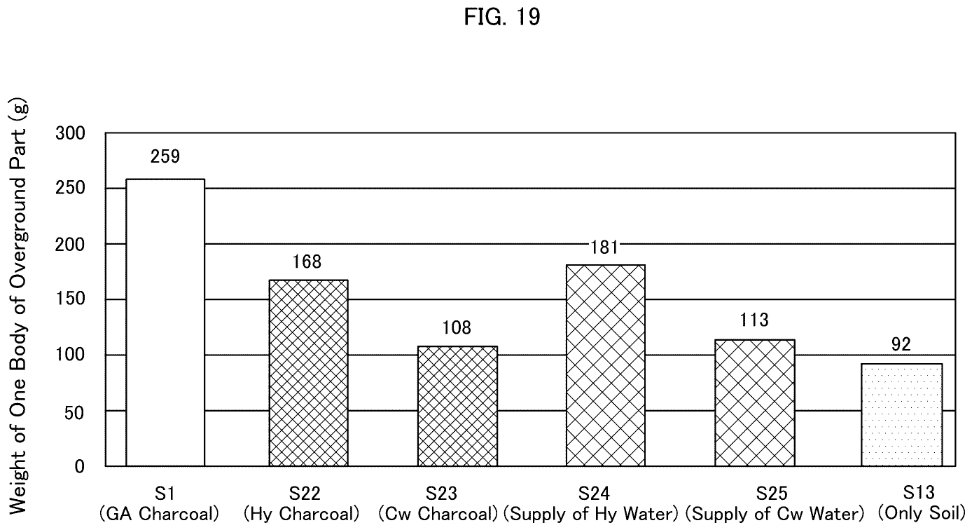

FIG. 19 is an explanatory diagram showing the results of the plant growth test or more specifically showing the measurement results of the raw weight of the overground part after elapse of 12 days since seeding, with regard to the sample group S1 (with use of the GA charcoal as the mixed material), the sample group S22 (with use of the Hy charcoal as the mixed material), the sample group S23 (with use of the Cw charcoal as the mixed material), the sample group S24 (with no use of the mixed material and with supply of the Hy water), the sample group S25 (with no use of the mixed material and with supply of the Cw water), and the sample group S13 (with use of only the soil).

As shown in FIG. 19, the sample group S22 (with use of, as the mixed material, the Hy charcoal obtained by adsorption of the components of the liquid fertilizer decomposed by microorganisms presumed to exist for two weeks) more effectively promoted the growth of a plant, compared with the case of using only the soil (S13). The plant growth effect in this case was, however, less than the effect in the sample group S1 with application of the GA charcoal. The growth effect of the sample group S22 was equivalent to the growth effect of the sample group S18 with application of the liquid fertilizer without a decomposition period (as shown in FIG. 16). It is thought that the improvement in the growth effect of the sample group S22 is ascribed to a trace amount of an inorganic fertilizer adsorbed to the adsorbent. Consideration on the involvement of bacteria in the improvement of the growth effect of the sample group S22 may suggest the possibility of the involvement of bacteria derived from water (well water) and grown on the adsorbent. The growth effect of the sample group S22 was, however, equivalent to the sample group S18 with application of a liquid fertilizer without a decomposition period. It is accordingly considered that bacteria derived from well water or derived from the air have no substantial power of enhancing the plant growth effect.

As shown in FIG. 19, the growth in the sample group S23 (with use of, as the mixed material, the Cw charcoal obtained by adsorption of the components of the pellets of cattle manure compost decomposed by microorganisms presumed to exist for two weeks) was substantially equivalent to the growth in the case of using only the soil (S13). The growth effect of the sample group S23 was less than the growth effects of the sample groups S20 and S21 with direct application of the pellets of cattle manure compost to the soil (as shown in FIG. 18). Consideration on the involvement of bacteria in the growth effect of the sample group S23 may suggest the possibility of the involvement of bacteria derived from well water or derived from the air and grown on the adsorbent and the possibility of the involvement of bacteria derived from the pellets of cattle manure compost. As described above, however, it is considered that bacteria derived from well water or derived from the air have no substantial power of enhancing the plant growth effect. Furthermore, the less growth effect of the sample group S23 than the growth effects of the sample groups S20 and S21 with direct application of the pellets of cattle manure compost suggests that bacteria derived from the pellets of cattle manure compost, i.e., bacteria derived from a land sphere to generally act in the process of composting, do not exert the power of improving the plant growth effect. Based on these results, it is concluded that a bacterium derived from the water sphere where an aquatic organisms is grown or more preferably a bacterium derived from fish is important for improving the growth effect of a land plant and that a carbon material is a preferable material for transferring the bacterium in the water sphere described above to the land sphere.

As shown in FIG. 19, the sample group S24 (with no use of the mixed material and with supply of the Hy water) more effectively promoted the growth of a plant, compared with the case of using only the soil (S13). The plant growth effect in this case was, however, less than the effect in the sample group S1 with application of the GA charcoal. The growth effect of the sample group S24 was equivalent to the growth effect of the sample group S18 with application of the liquid fertilizer without a decomposition period (as shown in FIG. 16). The growth effect of the sample group S24 was higher than the growth effect in the case of using only the soil (S13). These results may be ascribed to that both the Hy water shown in FIG. 4 and the 500-fold diluted HYPONeX used in the sample group S18 have EC values of larger than 1000 (uS/cm) and can thus provide equivalent levels of an inorganic fertilizer component to the plant. Bacteria involved in the plant growth effect may be bacteria derived from well water or derived from the air and grown in the water in the process of obtaining the Hy water. As described above, however, it is considered that bacteria derived from well water or derived from the air have no substantial power of enhancing the plant growth effect.

As shown in FIG. 19, the growth in the sample group S25 (with no use of the mixed material and with supply of the Cw water) was substantially equivalent to the grown in the case of using only the soil (S13). The growth effect of the sample group S25 was less than the growth effects of the sample groups S20 and S21 with direct application of the pellets of cattle manure compost to the soil (as shown in FIG. 18). Consideration on the involvement of bacteria in the growth effect of the sample group S25 may suggest the possibility of the involvement of bacteria derived from well water or derived from the air and grown on the adsorbent and the possibility of the involvement of bacteria derived from the pellets of cattle manure compost. As described above, however, it is considered that bacteria derived from well water or derived from the air have no substantial power of enhancing the plant growth effect. Furthermore, the less growth effect of the sample group S25 than the growth effects of the sample groups S20 and S21 with direct application of the pellets of cattle manure compost suggests that bacteria derived from the pellets of cattle manure compost, i.e., bacteria derived from a land sphere to generally act in the process of composting, do not exert the power of improving the plant growth effect. Based on these results, it is concluded that a bacterium derived from the water sphere where an aquatic organisms is grown or more preferably a bacterium derived from fish is important for improving the growth effect of a land plant.

### <Environmental DNAAnalysis in Water for Growth>

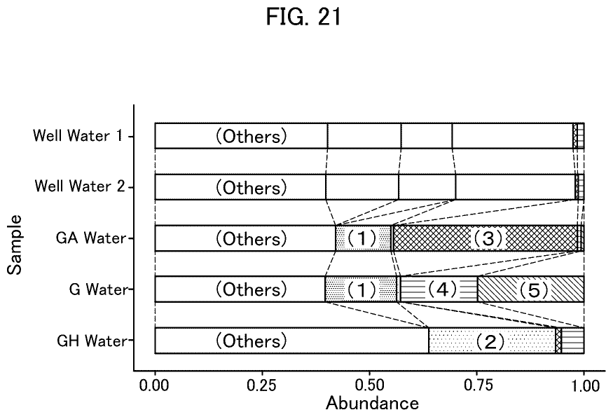

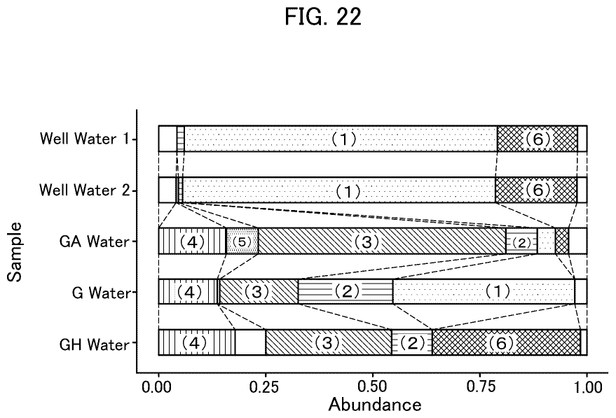

Environmental DNA analysis in the water for growth was performed by a procedure described below. The procedure first collected 100 ml of each of the GA water, the G water, and the GH water as the water for growth from each of the water tanks shown in FIG. 2A to FIG. 2C, for the purpose of genomic DNA extraction and kept these waters for growth at 4 °C. The procedure was then filtered each of these waters for growth by using a filter funnel for analytical test 145-0020 (Thermo Scientific Nalgene). The procedure then divided each membrane after filtering into quarters, placed two of the quarters into two bead tubes of ZymoBIOMICS DNA/RNA Miniprep Kit (manufactured by Zymo Research) and kept the tubes at −80 °C until DNA extraction. The procedure subsequently performed DNA extraction according to a protocol of this kit and performed PCR amplification of a V4 region of 16S rRNA with regard to each extracted DNA by using both a forward primer and a reverse primer. The environmental DNA analysis in the water for growth was performed with regard to well waters as comparative examples (N=2: shown as well water 1 and well water 2 in FIG. 21 and FIG. 22 described later), as well as the GA water, the G water and the GH water as the waters for growth.

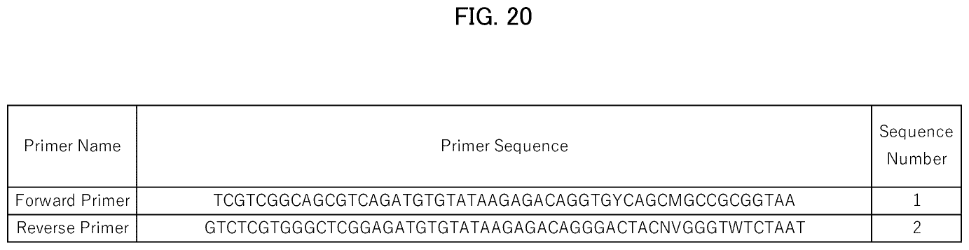

FIG. 20 is an explanatory diagram showing primer sequences used in the PCR amplification described above. The procedure purified the amplification products by using AMPure XP (Beckman Coulter, Inc.), further added a sequence adapter and an Index sequence by using Nextera XT Index Kit V2 Set D (Illumina, Inc.) and again performed PCR amplification. The amplification products obtained were again purified by using AMPure XP. A library was produced by diluting a mixture of equal amounts of the amplification products with regard to each sample to 50 pM and adding 20% of PhiX (Illumina, Inc.) as a control library. The produced library was subjected to 300-bp single end sequencing by using Illumina iSeq100 (manufactured by Illumina, Inc.) (iSeq: registered trademark) as a sequencer.

The procedure removed adapter sequences and performed filtering with an error ratio of 0.25 from an FASTQ file obtained as a result of the sequencing by using a plugin DADA2 (DADA2: High-resolution sample inference from Illumina amplicon data. Nat Methods. 2016; 13, 581-583) of QIIME2 (Reproducible, interactive, scalable and extensible microbiome data science using QIIME2. Nat Biotechnol. 2019; 37, 852-857) as an analysis pipeline for amplicon sequencing, and subsequently obtained representative sequences. The procedure checked the obtained representative sequences by referring to a reference sequence database to perform systematics in a genus level and subsequently calculated the occupancies of the respective genera. The procedure also performed principal coordinates analysis based on UniFrac distances by using plugin diversity. The procedure further calculated a microbiome derivation ratio of the well water with regard to each sample by using Source Tracker2 (Bayesian community-wide culture-independent microbial source tracking. Nat methods. 2011; 8, 761-763) as a prediction tool of an isolation source of bacteria based on Bayesian statistics. The procedure further confirmed the relationship of the microbiome bacterial species composition of each sample to the environment by using VITCOMIC2 (VITCOMIC2: visualization tool for the phylogenetic composition of microbial communities based on 16S rRNA gene amplicons and metagenomic shotgun sequencing. BMC Syst Biol., 2018; 12 (30), Suppl 2) as a tool for estimating the bacterial community systematic composition and LEA (Latent environment allocation of microbial community data. PLoS Comput Biol. 2018; 14(6), e1006143) as a web tool for estimating the environment from microbial communities.

FIG. 21 is an explanatory diagram showing information with regard to a bacterial flora distribution obtained from environmental DNA analysis by next-generation sequencing performed as described above. In FIG. 21, (1) and (2) show bacteria of a Rhizobiales f (Rhizobiaceae family) as a family of gram-negative, non-sporulating aerobic bacillus. In FIG. 21, (1) shows Rhizobiales incertae Sedis. g uncultured as uncultured bacteria of an undetermined genus; and (2) shows Devosiaceae. g Devosia. The Rhizobiaceae family includes bacteria present in the roots of plants and more specifically include root nodule bacterium and Agrobacterium having the nitrogen fixation capacity. (3) shows a non-microbial, chloroplast-derived substance. The GA water has been collected under the conditions of aquaponics, so that (3) is presumed to be derived from a plant of a hydroponic culture tank. (4) shows one genus of Flavobacteria. The bacteria of this genus include pathogenic bacteria of fish. Bacterial gill disease bacillus (F. branchiophira) of fish is known as a salmonid bacillus, and Flavobacterium (F. balustinum) is known as a bacillus of sea fish in the USA. Another example is F. meningosepiticum, which a newborn baby or an underweight baby is infected with to cause purulent meningitis (the fatality rate of approximately 55%) and which develops endocarditis of a grown-up. (5) is included in Chitinophagaceae family, and Ferruginibacter genus belonging to the same family is separated from freshwater sediment.

As shown in FIG. 21, it has been recognized that the Rhizobiaceae family is dominant in the bacterial flora distribution of the waters for growth. More specifically, it has been found that Rhizobiales incertae Sedis. g uncultured and Devosiaceae. g Devosia in this family are dominant. These bacteria are taxonomically kin to the endophyte, the root nodule bacterium and the like in the roots and are suggested to be related to the growth of plants.

FIG. 22 is an explanatory diagram showing the results of Topic analysis from the information with regard to the bacterial flora distribution obtained from the environmental DNA analysis by next-generation sequencing. In FIG. 22, (1) shows a biofilm (a membrane used to ensure the microbial growing environment). (2) shows the endophyte, the root nodule bacterium, and the rhizosphere (soil space affected by secretions of the roots of plants and soil microorganisms). These have been detected in all the waters for growth (the GA water, the G water and the GH water). The G water, which provides the G charcoal having the highest effect of growing Japanese mustard spinach (Komatsuna) has the highest ratio of (2). These results suggest the relationship of ammonia and charcoal to the growth environment. (3) shows water, clear water, sewage, rivers, and lakes; (4) shows bowels and mice, which may be derived from feed given to fish, intestinal bacteria, excrement, and infecting bacteria on the body surface; (5) shows sludge and sewage; and (6) shows cultivated land.

As shown in FIG. 22, it has been recognized that the microbial group (2), such as the encophyte in the roots, is suggested to be related to the growth of plants is dominant. These results have also suggested the presence of useful bacteria, other than the bacteria of the Rhizobiaceae family specified in FIG. 21 (Rhizobiales incertae Sedis. g uncultured and Devosiaceae. g Devosia).

The present disclosure is not limited to the embodiment described above but may be implemented in a variety of configurations without departing from the subject matter or the scope of the present disclosure. For example, the technical features of the embodiment corresponding to the technical features of the respective aspects described in Summary may be appropriately changed, altered, replaced or combined, in order to solve part or the entirety of the problems described above or in order to achieve part or the entirety of the advantageous effects described above. The technical features may be appropriately omitted unless the technical features are mentioned as essential in the description hereof.

### REFERENCE SIGNS LIST

10 . . . aquaponics system
11 . . . aquatic organism
12 . . . fish culture tank
13 . . . adsorbent
14 . . . cultivation water tank
15 . . . medium
16 . . . first circulation flow path
17 . . . plant body
18 . . . second circulation flow path
22 . . . water tank

1. A method for producing a plant growth promoter, comprising:
providing an adsorbent configured to adsorb at least one of a bacterium and an organic substance;
soaking the adsorbent in water for growth where an aquatic organism is grown; and
obtaining the adsorbent taken out from the water for growth, as the plant growth promoter.

2. The method for producing the plant growth promoter according to claim 1,
wherein the adsorbent comprises a carbon material or a biological organic material.

3. The method for producing the plant growth promoter according to claim 1,
wherein the adsorbent is porous or fibrous.

4. The method for producing the plant growth promoter according to claim 1,
wherein the water for growth has a concentration of nitrate ion of not lower than 50 ppm.

5. The method for producing the plant growth promoter according to claim 1,
wherein soaking of the adsorbent in the water for growth is performed for a time period of one day to one week.

6. A method for growing a plant, comprising:
applying the plant growth promoter produced by the method according to claim 1, to a land plant.

7. The method for growing the plant according to claim 6, further comprising:
applying the plant growth promoter to soil used for cultivation of the land plant.

8. The method for growing the plant according to claim 6, further comprising:
applying the plant growth promoter to a medium used for hydroponic culture of the land plant.

9. The method for growing the plant according to claim 7,
wherein an amount of application of the plant growth promoter to the soil is not lower than 10% by volume and not higher than 50% by volume.

10. The method for producing the plant growth promoter according to claim 2,
wherein the adsorbent is porous or fibrous.

11. The method for producing the plant growth promoter according to claim 4,
wherein soaking of the adsorbent in the water for growth is performed for a time period of one day to one week.

12. The method for growing the plant according to claim 8,
wherein an amount of application of the plant growth promoter to the medium is not lower than 10% by volume and not higher than 50% by volume.
